(19) United States
(12) Patent Application Publication
(10) Pub. No.: US 2015/0060281 A1
(43) Pub. Date: Mar. 5, 2015

(54) METHOD FOR MANUFACTURING METAMATERIAL

(71) Applicants: TOKYO INSTITUTE OF TECHNOLOGY, Meguro-ku (JP); Asahi Glass Company, Limited, Chiyoda-ku (JP)

(72) Inventors: Tomokazu IYODA, Meguro-ku (JP); Hironori ATARASHI, Meguro-ku (JP); Nanae YAMASHITA, Meguro-ku (JP); Kaori KAMATA, Meguro-ku (JP); Kenji KITAOKA, Chiyoda-ku (JP)

(73) Assignees: TOKYO INSTITUTE OF TECHNOLOGY, Meguro-ku (JP); Asahi Glass Company, Limited, Chiyoda-ku (JP)

(21) Appl. No.: 14/336,196

(22) Filed: Jul. 21, 2014

(30) Foreign Application Priority Data
Aug. 27, 2013 (JP) 2013-176030

(51) Int. Cl. G02B 6/132

(52) U.S. Cl. CPC G02B 6/132; G02B 2006/12166
USPC 204/483

(57) ABSTRACT

A method for manufacturing a metamaterial including an electromagnetic wave resonator that resonates with an electromagnetic wave is provided. In the method, a support including a portion where the electromagnetic wave resonator is to be formed is formed, and the electromagnetic wave resonator is arranged in the support by depositing a material to form the electromagnetic wave resonator on the portion of the support. The support is formed by forming a column structure of a hydrophilic/hydrophobic phase-separated film including a hydrophilic liquid phase area penetrating through in a thickness direction, by packing a filler into the column structure of the hydrophilic/hydrophobic phase-separated film including the hydrophilic liquid phase area so as to form the filler as high as the column structure, and by obtaining the support including the filler by removing at least a part of the hydrophilic/hydrophobic phase-separated film.

### CROSS-REFERENCE TO RELATED APPLICATIONS

This patent application is based upon and claims the benefit of priority of Japanese Patent Application No. 2013-176030, filed on Aug. 27, 2013, the entire contents of which are incorporated herein by reference.

### BACKGROUND OF THE INVENTION

1. Field of the Invention

The present invention relates to a method for manufacturing a metamaterial.

2. Description of the Related Art

A variety of techniques relating to a method for manufacturing a metamaterial and a metamaterial has been disclosed until now.

For example, Japanese Laid-Open Patent Application Publication No. 2006-350232 discloses a metamaterial configured by arranging a plurality of resonators composed of at least one of electrical resonators and magnetic resonators that are smaller than a wavelength of light in a predetermined plane. Also, Japanese Laid-Open Patent Application Publication No. 2009-57518 discloses a method for manufacturing an anisotropic film including a step of forming a metal nanostructure on a base material, a step of forming a resin film in which the metal nanostructure is embedded and a step of peeling off the resin film from the base material. In the method, the step of forming the metal nanostructure on the base material includes at least a step of forming a coating film including a metal layer formed by electroless plating on a surface of a mold provided on the base material and a step of removing a part or all of the mold while leaving a part or all of the coating film.

A conventional and general method for manufacturing a metamaterial uses a lithography technique and an etching technique in manufacturing an electromagnetic wave resonator. However, in such a method, for example, when manufacturing (mass-producing) a metamaterial including a minute electromagnetic wave resonator or the like, the electromagnetic wave resonator is liable to vary in size, shape and the like. Because of this, in the conventional method, even though producing the metamaterial at a laboratory level is possible, mass-producing the metamaterial efficiently (at a good yield rate) is thought to be difficult.

### SUMMARY OF THE INVENTION

Embodiments of the present invention provide a novel and useful method for manufacturing a metamaterial solving one or more of the problems discussed above.

More specifically, the embodiments of the present invention may provide a more efficient method for manufacturing a metamaterial.

According to an embodiment of the present invention, there is provided a method for manufacturing a metamaterial including an electromagnetic wave resonator that resonates with an electromagnetic wave, the method including steps of:
(a) forming a support including a portion where the electromagnetic wave resonator is to be formed; and
(b) arranging the electromagnetic wave resonator on the support by evaporating a material to form the electromagnetic wave resonator and depositing the evaporated material on the portion of the support,

wherein the step of forming the support includes steps of:
(c) forming a column structure of a hydrophilic/hydrophobic phase-separated film including a hydrophilic liquid phase area penetrating through in a thickness direction on a substrate;
(d) packing a filler into the column structure of hydrophilic/hydrophobic phase-separated film including the hydrophilic liquid phase penetrating through in the thickness direction so as to form the filler as high as the column structure; and
(e) obtaining the support including the filler by selectively removing at least a part of the hydrophilic/hydrophobic phase-separated film from the hydrophilic/hydrophobic phase-separated film including the filler.

### BRIEF DESCRIPTION OF THE DRAWINGS

FIG. 1 is a schematic flowchart illustrating an example of a method for manufacturing a metamaterial according to an embodiment of the present invention;

FIGS. 2A through 2E are diagrams schematically illustrating each process of the method for manufacturing the metamaterial according to the embodiment of the present invention;

FIGS. 3A through 3E are diagrams illustrating each process of another example of the embodiment of the present invention;

FIG. 4A is an enlarged perspective view illustrating a part of a metamaterial;

FIG. 4B is an enlarged top view schematically illustrating a part of the metamaterial;

FIGS. 5A through 5C are diagrams for explaining a method for evaluating characteristics of resonance of an electromagnetic wave resonator in response to a certain frequency of the electromagnetic resonator;

FIG. 6 is a diagram schematically illustrating an embodiment of a metamaterial;

FIG. 7 is a diagram schematically illustrating another embodiment of the metamaterial;

FIG. 8 is a TEM image showing an example of column structure according to an embodiment of the present invention; and

FIG. 9 is a graph showing an optical absorption spectrum of an example of the embodiment of the present invention.

### DETAILED DESCRIPTION OF THE PREFERRED EMBODIMENT

A description is given below of embodiments of the present invention, with reference to the accompanying drawings.

In the embodiments, there is provided a method for manufacturing a metamaterial including an electromagnetic wave resonator that resonates with an electromagnetic wave, the method including steps of:
(a) forming a support including a portion in which the electromagnetic wave resonator is to be formed; and
(b) arranging the electromagnetic wave resonator on the support by evaporating a material to form the electromagnetic resonator and by depositing the evaporated material on the portion of the support,

wherein the step of forming the support includes steps of:
(c) forming a column structure of a hydrophilic/hydrophobic phase-separated film including a hydrophilic liquid phase area penetrating in a thickness direction on a substrate;
(d) packing a filler into the column structure of the hydrophilic/hydrophobic phase-separated film including the hydrophilic liquid phase area penetrating in the thickness direction by forming the filler up to a same height as that of the column structure; and
(e) obtaining the support including the filler by selectively removing at least a part of the hydrophilic/hydrophobic phase-separated film from the hydrophilic/hydrophobic phase-separated film including the filler.

A conventional and general method for manufacturing a metamaterial uses a lithography technique and an etching technique in manufacturing an electromagnetic wave resonator. However, in such a method, for example, when manufacturing (mass-producing) a metamaterial including a minute electromagnetic wave resonator or the like, the electromagnetic wave resonator is liable to vary in size, shape and the like. Because of this, in the conventional method, even though producing the metamaterial at a laboratory level is possible, mass-producing the metamaterial efficiently (at a good yield rate) is thought to be difficult.

In response to this, in the embodiment, the support used in arranging the electromagnetic wave resonator is manufactured by steps of:
forming a column structure of a hydrophilic/hydrophobic phase-separated film including a hydrophilic liquid phase area penetrating in a thickness direction on a substrate;
packing a filler into the column structure of the hydrophilic/hydrophobic phase-separated film including the hydrophilic liquid phase area penetrating in the thickness direction by forming the filler at a same height as that of the column structure; and
obtaining the support including the filler by selectively removing at least a part of the hydrophilic/hydrophobic phase-separated film from the hydrophilic/hydrophobic phase-separated film including the filler.

In this case, as described later, a support including an extremely minute column shaped pattern can be manufactured precisely and readily.

Moreover, in the method for manufacturing the metamaterial according to the embodiment of the present invention, the electromagnetic resonator is arranged on the support by a vapor deposition method. In this case, a lithography technique that could cause a relatively large precision error is not used, and the metamaterial can be manufactured with a high degree of accuracy and reproducibility.

Furthermore, according to the method for manufacturing the metamaterial according to the embodiment of the present invention, an area of the support can be readily made larger and the metamaterial can be efficiently mass-produced.

[Microphase Separation Phenomenon of Block Copolymer]

In the method for manufacturing the metamaterial according to the embodiment of the present invention, a microphase separation phenomenon of a block copolymer is utilized as a method for forming the column structure of the hydrophilic/hydrophobic phase-separated film including the hydrophilic liquid phase area penetrating in the thickness direction. A simple description is given below of the utilized microphase separation phenomenon of the block copolymer.

The block copolymer including both of a hydrophilic polymer chain and a hydrophobic polymer chain is known to undergo phase separation to cause both of the chains to separate from each other under predetermined (heat treatment) conditions and to show a characteristic microstructure (i.e., microphase separation phenomenon), as disclosed, for example, in Japanese Laid-Open Patent Application Publication No. 2012-1787.

For example, a block copolymer (1) expressed by the following chemical formula readily undergoes phase separation by heat treatment and forms a column structure including a hydrophilic phase of a hexagonal arrangement because a hydrophilic polymer chain (part of A in formula (1)) and a hydrophobic polymer chain (part of Z in formula (1)) are incompatible with each other.

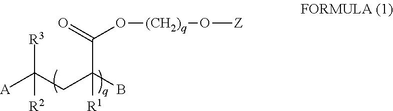

Here, a “R¹” and a “R²” are a hydrogen atom or a alkyl group, and a “R³” is a methyl group. A “p” is an integer of 4 to 30, and a “q” is an integer of 5 to 500. An “A” is a hydrophilic polymer chain; a “B” is a halogen atom; and a “Z” is a liquid-crystalline mesogenic chain.

In the embodiment, a block copolymer (PEO-b-PMA (Az)) including a polyethylene oxide (PEO) as the hydrophilic polymer chain and a polymethacrylate derivative (PMA (Az)) as the hydrophobic polymer chain is used among the block copolymer expressed by formula (1).

A diameter of the hydrophilic phase and a pitch of adjacent hydrophilic phases in the column structure can be controlled by surface conditions of an object to be treated (e.g., a substrate) forming the column structure, heat treatment conditions, a type and a chain length of the hydrophilic polymer chain, a type and a chain length of the hydrophobic polymer chain and the like. More specifically, a person skilled in the art can adjust, for example, from an extremely minute column having a diameter of about 3 nm to a relatively large column having a diameter of about 100 nm.

Moreover, the diameter of the hydrophilic phase and the pitch of the adjacent hydrophilic phases in the column structure are known to be controlled by mixing block copolymers having different molecular weights of the PEO with each other (e.g., see S. Y. Jung and H. Yoshida, J. Therm Anal. Cal., 85 (2006) 3, 719-724).

This column structure including the hydrophilic phase contains the hydrophilic polymer chain therein in a liquid phase state. In other words, the column structure of the hydrophilic/hydrophobic phase-separated film including the hydrophilic liquid phase area penetrating in the thickness direction is formed. Due to the liquid phase state, the hydrophilic filler can be packed into the column structure through a coordinate bond and an ionic bond by a method described later. As a result, the microphase separation film in which the filler is formed into a column shape can be obtained.

When the fillers formed into the column shape are applied to the support for the metamaterial, the fillers are required to be precisely arranged at a constant height. Accordingly, in the embodiment, when the filler is formed in the column of the hydrophilic liquid phase, the filler is formed to be the same height as that of the column structure by a method described later and the like. This makes it possible to form the support for the metamaterial so as to be precisely arranged at a constant height.

After that, the hydrophilic/hydrophobic phase-separated film is selectively removed from the fillers, and the support constituted of the fillers is finally obtained.

In such a method of manufacturing the support, the support having an extremely minute column-like pattern can be precisely and easily manufactured. Moreover, the hydrophilic/hydrophobic phase-separated film having the column structure of the hydrophilic liquid phase and utilized for manufacturing the support is so-called “spontaneously” formed by the heat treatment of the block copolymer. Hence, in the embodiment of the present invention, a too special apparatus and/or environment is not prepared, and furthermore, the support having a large area can be easily manufactured.

There is another method depending on conductivity of an aluminum thin film, a silicon thin film or the like or anode oxidation of a semiconductive thin film as a method of forming the column structure of a porous film having a hole penetrating in the thickness direction similar in structure to the column structure of the hydrophilic/hydrophobic phase-separated film having the hydrophilic area penetrating in the thickness direction. Even though this method does not match the method utilizing the microphase separation of the block copolymer in productivity because forming concavities and convexities in a surface to control the arrangement of the column structure, and controlling a current precisely by electrochemical reaction for the anode oxidation and the like are needed, forming a similar column structure is possible. On the other hand, in a case of the column structure of the porous film by the anode oxidation, it is difficult to remove at least a part and to obtain a support like the block copolymer according to the embodiment of the present invention.

[Method for Manufacturing Metamaterial of Embodiment]

Next, a detailed description is given below of the method of manufacturing the metamaterial according to an embodiment of the present invention with reference to the drawings.

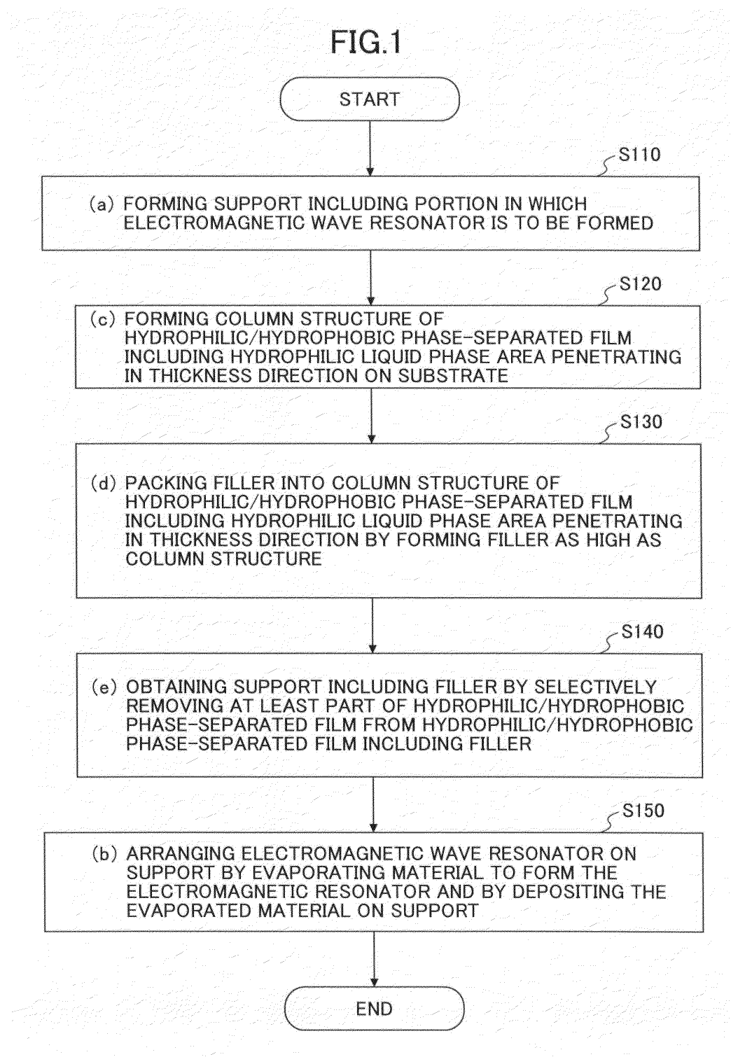

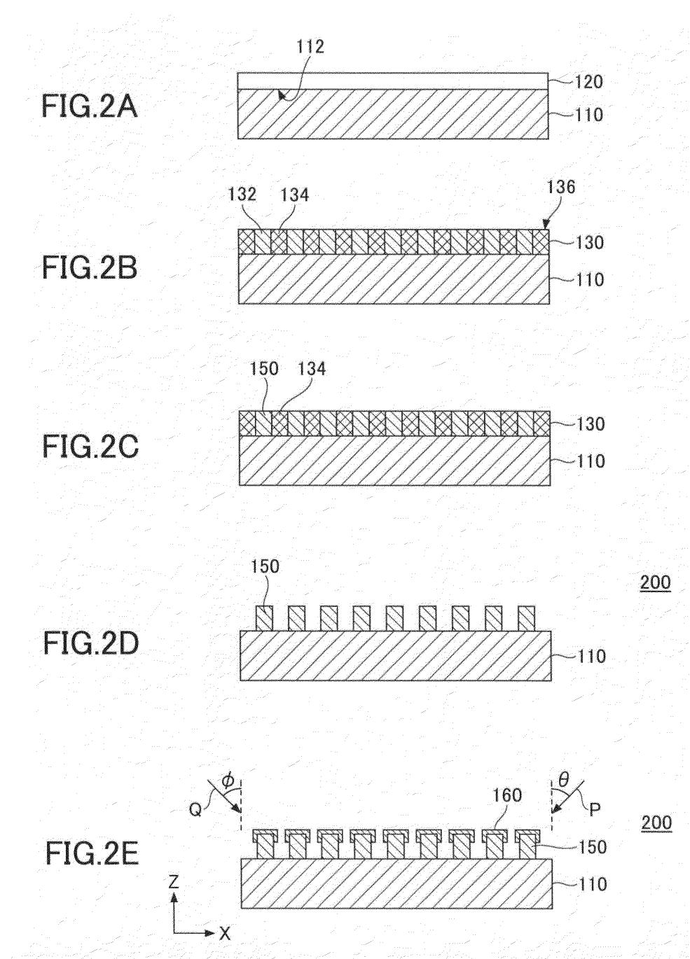

FIG. 1 illustrates a schematic flowchart of an example of the method of manufacturing the metamaterial according to an embodiment of the present invention. FIG. 2 schematically illustrates each process in the method of manufacturing the metamaterial of according to the embodiment of the present invention.

As illustrated in FIG. 1, the method of manufacturing the metamaterial according to the embodiment includes steps of:
(a) forming a support including a portion in which an electromagnetic wave resonator is to be formed (S110); and
(b) arranging the electromagnetic wave resonator on the support by evaporating a material and by depositing the evaporated material to form the electromagnetic wave resonator on the portion of the support (S150),

wherein the step of forming the support (S110) includes steps of:
(c) forming a column structure of a hydrophilic/hydrophobic phase-separated film including a hydrophilic liquid phase area penetrating in a thickness direction on a substrate (S120);
(d) packing a filler into the column structure of the hydrophilic/hydrophobic phase-separated film including the hydrophilic liquid phase area penetrating in the thickness direction by forming the filler at a same height as that of the column structure (S130); and
(e) obtaining the support including the filler by selectively removing at least a part of the hydrophilic/hydrophobic phase-separated film from the hydrophilic/hydrophobic phase-separated film including the filler (S140).

Hereinafter, a description is given with respect to each step.

(Step S110)

To begin with, a support including a portion on which an electromagnetic wave resonator is to be formed is formed.

The support is formed by way of the following steps S120 through S140.

(Step S120)

As illustrated in FIG. 2A, first, a substrate 110 having a first surface 112 is prepared.

The substrate 110 serves to support a hydrophilic/hydrophobic phase-separated film on the first surface 112 later.

Although a material of the substrate 110 is not particularly limited, the material is preferred to have sufficient adhesion between the substrate 110 and the hydrophilic/hydrophobic phase-separated film. When the adhesion between the substrate 110 and the hydrophilic/hydrophobic phase-separated film is extremely poor, the hydrophilic/hydrophobic phase-separated film is liable not to be able to be properly installed on the substrate 110.

The substrate 110 may be made of a conductive material or a non-conductive material. A metal substrate or a substrate provided with a (transparent) conductive coating such as an ITO (Indium Tin Oxide) film or the like on a surface thereof is taken as an example of the conductive substrate. A glass substrate and a resin substrate are taken as examples of the non-conductive substrate.

In addition, in order to control a state of surface energy of the substrate 110, a SAM (Self Assembled Monolayer) film may be formed on the surface of the substrate 110 by applying a SAM material to the surface of the substrate 110. In this case, the surface of the SAM film becomes the first surface 112.

Next, a block copolymer film 120 is provided on the first surface 112.

The block copolymer, as discussed above, undergoes the microphase separation phenomenon under a predetermined environment, and the kind is not limited as long as a column structure including a hydrophilic liquid phase of a hexagonal arrangement is formed. Such a block copolymer may be, for example, the block copolymer expressed by the above-mentioned formula (1).

Although a method of forming the block copolymer film 120 on the substrate 110 is not particularly limited, for example, by coating an application liquid made by dissolving the block copolymer in an organic solvent on the substrate 110 by a spin coating method or a spray coating method, the block polymer film 120 can be formed on the substrate 110.

Next, by treating the substrate 110 having the block copolymer film 120 with heat, the block copolymer film 120 is caused to realize the microphase separation phenomenon.

Although a heat treatment temperature varies depending on kinds of the block copolymer film 120, for example, when a melting point of the block copolymer film 120 is made Tm (° C.), the heat treatment temperature may be in a range of (Tm−50) to (Tm+30)° C.

This causes a hydrophilic/hydrophobic phase-separated film 130 as illustrated in FIG. 2B to be formed. The hydrophilic/hydrophobic phase-separated film 130 is constituted of a part of columns 132 of a penetrating hydrophilic liquid phase and a part of columns 134 of a hydrophobic solid phase. The hydrophilic/hydrophobic phase-separated film 130 has a column structure 136 including the columns 132 of the hydrophilic liquid phase of the hexagonal arrangement under predetermined conditions.

Although the diameter of the columns 132 of the hydrophilic liquid phase is not particularly limited, for example, the diameter may be in a range of 3 to 100 nm.

(Step S130)

Next, in the substrate 110 including the hydrophilic/hydrophobic phase-separated film 130, a filler 150 is packed into the columns 132 of the hydrophilic liquid phase. At this time, it is important for the filler to be formed as high as the column structure.

The filler may be a conductive material or a non-conductive material (e.g., ceramics). For example, a metal is taken as an example of the conductive filler, and oxide such as silicon oxide (SiO₂), cerium oxide (CeO₂), titanium oxide (TiO₂) and the like are taken as examples of the non-conductive filler.

Hereinafter, a description is given of this process by taking an example of packing the filler 150 containing CeO₂ into the columns 132 of the hydrophilic liquid phase by using electrodeposition. Here, in a method of utilizing the electrodeposition, it is possible to pack the conductive filler 150 such as a metal into the part of the columns 132 as electroplating.

To begin with, an electrodeposition process is performed on the substrate 110 provided with the hydrophilic/hydrophobic phase-separated film 130.

Here, when the substrate 110 has conductivity, this substrate 110 can be used as it is. In contrast, when the substrate 110 is a non-conductive substrate, by preliminarily performing vapor deposition of a conductive material, electroless plating or the like, the substrate 110 is made conductive.

When the electrodeposition process is performed on the substrate 110, filler deposition occurs only in the columns 132 of an alkaline hydrophilic liquid phase. From the feature, the height of the deposits becomes as high as the columns 132 of the hydrophilic liquid phase.

Moreover, as illustrated in FIG. 2C, the electrodeposition process is performed until the thickness of the deposits become as high as the column 132 of the hydrophilic liquid phase.

In this case, a mixture of hydroxide, oxide and the like of Ce are packed as the deposits 150.

Subsequently, a description is given below of another example of packing a filler into the part of the columns 132 of the hydrophilic liquid phase.

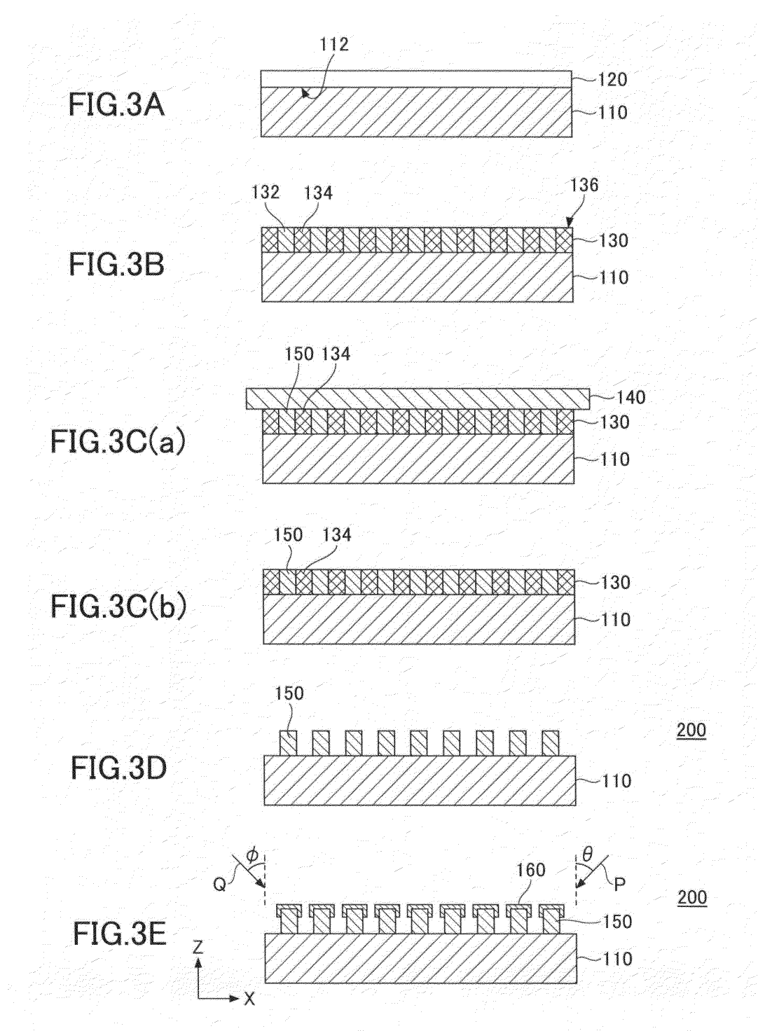

FIGS. 3A through 3E schematically illustrate each process in another example of the method of manufacturing the metamaterial of the embodiment. In the example illustrated in FIGS. 3A through 3E, a description is given of packing a non-conductive substance such as SiO₂ or the like as the filler, as an example. Furthermore, in FIGS. 3A through 3E, since processes until FIG. 3B and in and after FIG. 3D are similar to FIGS. 2A through 2E, the description regarding the similar processes is omitted.

First, a sol-like filler 150 is packed into a part of the columns 132 of the hydrophilic liquid phase including the hydrophilic/hydrophobic phase-separated film 130 by utilizing a general sol-gel method. At this time, because the column 132 is in a state of the liquid phase, the filler 150 is readily packed into the columns 132 through a coordinate bond and an ionic bond.

As illustrated in FIG. 3C (a), packing the filler 150 may be performed until exceeding the height of the column 132 of the hydrophilic liquid phase. In this case, as illustrated in FIG. 3C (a), the remaining part 140 of the filler 150 is formed on the top of the hydrophilic/hydrophobic phase-separated film 130. The sol-like filler turns into a gel by losing its fluidity. In FIG. 3C (a), the columns 132 are not depicted of the hydrophilic phase for clarification. Furthermore, a part over the height of the columns 132 of the filler 150 is formally called the remaining part 140.

Then, at least the remaining part 140 of the filler 150 having gelled is dried by a publicly known drying method. After that, the remaining part 140 is, for example, removed by peeling.

As a result, as illustrated in FIG. 3C (b), the fillers 150 as high as the columns 132 of the hydrophilic liquid phase can be formed.

In the embodiment of packing the sol-like filler 150, after forming the filler 150 as high as the columns 132 of the hydrophilic liquid phase by removing the remaining part 140, the sol-like fillers 150 have to be crosslinked (hardened) by, for example, an electron beam irradiation, oxygen plasma processing or heat treatment.

(Step S140)

Next, as illustrated in FIG. 3D, the hydrophilic/hydrophobic phase-separated film 130 is selectively removed from the top of the substrate 110.

The method of removing the hydrophilic/hydrophobic phase-separated film 130 is not particularly limited. The hydrophilic/hydrophobic phase-separated film 130 may be removed from the top of the substrate 110 by, for example, pyrolysis treatment, oxygen plasma treatment, dissolution treatment using organic solvent or the like.

By doing this, as illustrated in FIG. 3D, a support 200 constituted of the substrate 110 and the column-like fillers 150 can be obtained.

In FIG. 3D, the hydrophilic/hydrophobic phase-separated film 130 is completely removed, but only a part of the hydrophilic/hydrophobic phase-separated film 130 may be removed so that the hydrophilic/hydrophobic phase-separated film 130 remains at a base part of the column-like fillers 150. By removing the hydrophilic/hydrophobic phase-separated film 130 so as to leave the part of hydrophilic/hydrophobic phase-separated film 130 at the base part of the hydrophilic/hydrophobic phase-separated film 130, the column-like fillers 150 can be easily held vertically.

As discussed above, the columns 132 of the hydrophilic liquid phase of the hydrophilic/hydrophobic phase-separated film 130 are extremely minute, and are arranged in a highly precise manner. Accordingly, the support 200 includes the minute column-like fillers 150 arranged in a highly precise manner.

(Step S150)

Next, a metamaterial is produced by using the support 200 obtained by the processes discussed above.

More specifically, as illustrated in FIG. 3E, electromagnetic wave resonators 160 (which are, more exactly, material forming the electromagnetic resonators) are arranged at portions of the column-like fillers 150 of the support 200 by vapor deposition or the like.

A material forming the electromagnetic resonators may be at least one material selected from a group consisting of metal, graphene, indium tin oxide, zinc oxide, and tin oxide.

Here, as illustrated in FIG. 3E, the vapor deposition is preferred to be performed from a first direction P having a predetermined angle θ (0<θ<90 degrees) relative to an extending (lengthwise) direction of the column-like portions (fillers) 150 of the support 200. The angle θ expresses an angle in a clockwise direction relative to the lengthwise (height) direction of the column-like portions (fillers) 150 when seen from a direction perpendicular to an X-Z plane (i.e., a direction perpendicular to a plane of paper in FIG. 3E). This allows the electromagnetic wave resonators 160 to be deposited only on top end portion of the column-like fillers 150 of the support 200.

Moreover, as illustrated in FIG. 3E, if necessary, after that, further vapor deposition may be performed from a second direction Q having a predetermined angle θ (−90 degrees<φ<0) relative to the lengthwise direction of the column-like fillers 150 of the support 200. The angle φ expresses an angle in a counterclockwise direction relative to the lengthwise direction of the column-like portions (fillers) 150 when seen from a direction perpendicular to the X-Z plane (i.e., a direction perpendicular to a plane of paper in FIG. 3E). The angle φ may be the same as the angle θ in absolute value.

After performing twice such vapor depositions, when the support 200 is seen from a lateral side thereof, approximately inverted U-shaped electromagnetic wave resonators 160 can be arranged on the surfaces of the column-like fillers 150 of the support 200.

Such an arrangement of the approximately inverted U-shaped electromagnetic resonators 160 can be thought to be an arrangement of U-shaped inductors in an electric circuit. When an electromagnetic wave enters in a direction approximately perpendicular to the support 200, a magnetic component of the electromagnetic wave penetrates the U-shaped inductors, and a current flows in the electromagnetic wave by electromagnetic induction, and works to form a resistance magnetic field. This phenomenon is called magnetic resonance, in which a length of each end of a horseshoe (U-shape) of the electromagnetic wave resonator 160 can be changed by the vapor deposition angles φ, θ, and magnetic permeability and dielectric constant can be adjusted. This, for example, enables the electromagnetic wave resonator 160 to be utilized as a ring resonator (more specifically, Split Ring Resonator (SPR)) of a metamaterial, which can implement a negative refractive index by causing the magnetic permeability and the dielectric constant in a high frequency band right after a resonant frequency to both become negative values. According to reports, conventionally, a metamaterial including the SRR has been provided by forming the approximately U-shaped SRR and an approximately C-shaped SRR in a plane by a lithography technique and an etching technique. In order to realize the magnetic resonance by such SRRs, an electromagnetic wave has to be entered into the plane in which the SRRs are formed, or entered into the plane from an oblique direction to use the magnetic component in the plane direction, which makes it difficult to be used as an optical device. In contrast, the approximately inverted U-shaped SRR according to the embodiment of the present invention has an advantage of being easy for device application because the electromagnetic wave resonator works by causing the electromagnetic wave to enter the support from the direction perpendicular to the plane of the support as described above.

Kinds of the vapor deposition methods are not particularly limited. For example, the electromagnetic wave resonator 160 may be formed by a physical vapor deposition method or a chemical vapor deposition method.

The physical vapor deposition is a method of heating a solid material to evaporate the material and depositing a gas of the evaporated material on a surface of a substrate, or a method of bombarding a target with ions or high-energy particles and of depositing particles emanating from the target on the surface of the substrate.

Vacuum vapor deposition, sputtering, ion plating and the like are taken as specific examples of the physical vapor deposition. For example, the vacuum vapor deposition includes electron beam vapor deposition, resistance heating vapor deposition and the like. For example, the sputtering includes direct-current (DC) sputtering, alternating-current (AC) sputtering, radio-frequency (RF) sputtering, pulsed direct-current (DC) sputtering, magnetron sputtering and the like.

The chemical vapor deposition is a method of supplying a source gas containing a component of an intended thin film and depositing the intended thin film by a chemical reaction on a surface of a substrate or vapor phase deposition.

For example, the chemical vapor deposition includes thermal CVD, photo-CVD, plasma CVD, epitaxial CVD and the like.

A description is given below of an example of a method of forming a graphene film on the top end of each of the column-like portions of the support.

To begin with, a vapor deposition film of copper is deposited on the top end of each of the column-like portions of the support. This vapor deposition film of the copper is provided on the top end of each of the column-like portions of the support so as to form an approximate horseshoe shape by depositing the copper from two different directions by the physical vapor deposition for the support.

Next, a graphene film is deposited on the top end of each of the column-like portions of the support by the CVD method by using a mixed gas of methane, argon and hydrogen.

Although a flow rate of each gas is not limited, the flow rates may be methane 27 sccm, argon 18 sccm and hydrogen 9 sccm. Moreover, pressure during the film deposition may be 3 Pa; temperature during the film deposition may be 320° C.; and a time period during the film deposition may be 200 seconds.

Here, the vapor deposition film of copper functions as a catalyst layer in depositing the graphene film. Because of this, the graphene film is deposited only on a portion where the vapor deposition film of copper is provided among the column-like portions. This allows the approximately U-shaped graphene film to be deposited on the top end of each of the column-like portions.

Next, epoxy based resin (e.g., excel epo, transparent type; made by Cemedine CO, LTD.) is dropped and applied to the obtained support, and a quartz glass substrate given a liquid repellent process is pressed from above. This state is maintained for 20 minutes, thereby hardening the epoxy resin.

After that, by removing the quartz glass substrate, an assembly constituted of the support and the epoxy resin including the copper film and the graphene film is obtained.

Next, by immersing the assembly in a hydrogen sulfide water solution of 5% and by selectively dissolving the support and the copper film, a metamaterial made of the epoxy resin and including a concave pattern of the graphene film is produced.

[Regarding Structure of Metamaterial]

Next, a brief description is given of a configuration example of the metamaterial obtained by the above-mentioned manufacturing method of the embodiment of the present invention with reference to the drawings.

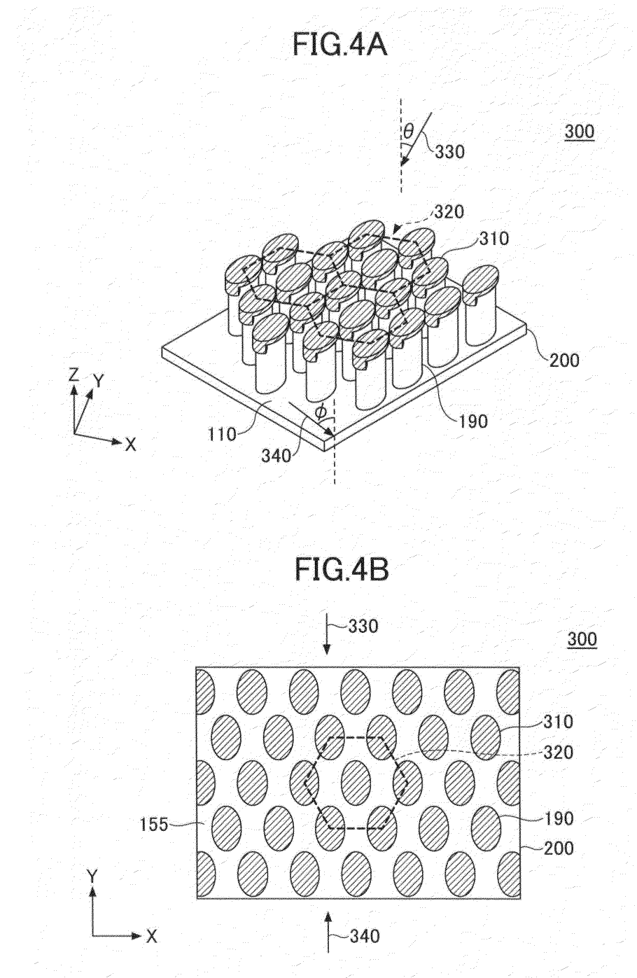

FIGS. 4A and 4B schematically illustrate a configuration example of a metamaterial obtained by the embodiment of the present invention. FIG. 4A illustrates an enlarged perspective view of a part of the metamaterial. Also, FIG. 4B illustrates an enlarged top view of a part of the metamaterial.

As illustrated in FIGS. 4A and 4B, the metamaterial 300 is constituted of a support 200 and electromagnetic wave resonators 310.

The support 200 includes a substrate 110 and columns 190 formed on the top of the substrate 110. The columns 190 are illustrated to be in a hexagonal arrangement so as to make it easy to understand as a model when seen from the top. FIGS. 4A and 4B illustrate a hexagonal unit arrangement 320 that constitutes a building block by using a dashed line for clarification.

The electromagnetic wave resonator 310 is arranged on the top surface and a part of the side surface of each of the columns 190 arranged to be in the hexagonal arrangement. More specifically, the electromagnetic wave resonator 310 is formed on the top end of each column 190 so as to be an approximately inverse U-shaped form when the metamaterial is seen from a horizontal direction (X direction in the drawing).

Here, such a metamaterial 300 is, for example, configured by depositing a vaporized material to form the electromagnetic wave resonator 310 on the support 200 from two directions inclined to a lengthwise direction (a Z direction) of each column 190.

For example, in the example of FIGS. 4A and 4B, a first vapor deposition is performed in a direction of an arrow 330 at first, and then a second vapor deposition is performed from a direction of arrow 340. Here, although the arrows 330 and 340 are in the same plane (XZ plane) perpendicular to the surface of the support 200, the arrows 330 and 340 are inclined in opposite directions to the lengthwise axis (Z axis) of the column from each other.

In this case, in the first vapor deposition from the side of the arrow 330, in the adjacent two columns 190, the column 190 on the downstream side and the support 200 are hidden by the column 190 on the upstream side. Because of this, the vapor deposition material comes not to be deposited on the whole side surface and the support 200 of each column 190. In other words, the vapor deposition material is deposited on the top surface and a part of the side surface of each of the columns 190.

Similarly, in the second vapor deposition from the side of the arrow 340, in two columns 190 adjacent to each other, the column 190 on the downstream side and the support 200 are hidden by the column 190 on the upstream side (It should be noted that a relationship between the upstream and the downstream is reverse to the first vapor deposition). Accordingly, the vapor deposition material comes not to be deposited on the whole side surface of each column 190 and the support 200. In other words, the vapor deposition material is deposited only on the top surface and the opposite side portion to the deposited portion of the side surface by the first vapor deposition.

Hence, this enables the electromagnetic wave resonators 310 to be formed on the top end of the columns 190 in an inverse U-shaped form.

Here, in the example of FIGS. 4A and 4B, the first direction (the direction of arrow 330) and the second direction (the direction of arrow 340) are each in a direction perpendicular to a side of the hexagon (Y direction in FIG. 4B) that constitutes a unit arrangement of the columns 190. However, since this is only an example, the first and second directions in the vapor deposition may be properly selected depending on a shape of the necessary electromagnetic wave resonator.

Moreover, because the hexagonal arrangement formed by the microphase separation includes a fluctuation of structure, when seen macroscopically by extending an area illustrated in FIG. 4B, the hexagonal arrangement may include a portion that does not form the hexagonal arrangement and has an off axis of an axis of rotational symmetry of the hexagonal arrangement, which may cause a shape distortion of the formed electromagnetic wave resonator and affect the magnetic field resonance effect. In such a case, a necessary portion may be properly selected in accordance with the purpose.

[Regarding Method of Evaluating Resonance two of Electromagnetic Wave Resonator]

A description is given below of a method of evaluating characteristics of resonance of an electromagnetic wave resonator in response to an electromagnetic wave of a certain frequency.

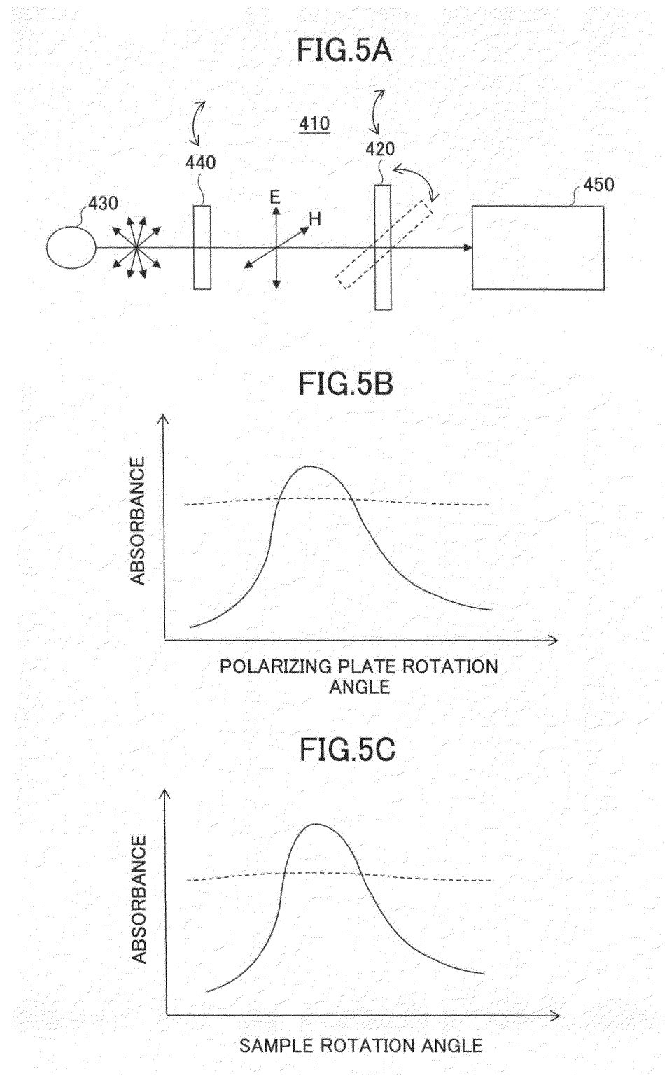

FIGS. 5A through 5C illustrate diagrams for explaining an apparatus that evaluates characteristics of resonance of an electromagnetic wave resonator.

As illustrated in FIG. 5A, the apparatus 410 that evaluates the characteristics of the resonance of a sample 420 including an electromagnetic resonator includes a light source 430, a polarizing plate 440, and a spectrophotometer 450. In the apparatus 410, the light source 430 emits non-polarized white light. The non-polarized white light emitted from the light source 430 passes through the polarizing plate 440. The white light having passed through the polarizing plate 440 is linear polarized light. Next, the linearly-polarized white light enters the sample 420. Among the linearly-polarized white light that has entered the sample 420, when linear polarized light of a resonant frequency resonates with the electromagnetic wave resonator contained in the sample 420, the linear polarized light of the resonant frequency is absorbed by the electromagnetic wave resonator contained in the sample 420. Therefore, an absorbance of the linear polarized light having passed through the sample 420 corresponding to a variety of wavelengths in white light is measured by using the spectrophotometer 450.

Next, instead of the electromagnetic wave resonator, an absorbance of a particle in the sample 420 corresponding to the wavelength of the linear polarized light is similarly obtained by using a (substantially) spherical particle made of the same material as that of the electromagnetic resonator. When a significant difference is observed between the absorbance of the electromagnetic wave resonator in the sample and the absorbance of the particle in the sample 420, it is determined that the electromagnetic wave resonator properly functions as an electromagnetic wave resonator.

Moreover, by using the apparatus 410 illustrated in FIG. 5A, whether the electromagnetic wave resonator is arranged randomly or regularly can be examined. The apparatus 410 preferably includes at least one of a unit to rotate the sample 420 and a unit to rotate the polarizing plate 440.

To begin with, after measuring the absorbance of the sample including the electromagnetic wave resonator by switching the wavelength, a wavelength that becomes a peak of the absorption is specified. Then, after setting the non-polarized white light emitted from the light source 430 at the specified wavelength, a change in the absorbance is observed while rotating the polarizing plate or the sample. Here, the change in absorbance of the sample 420 is observed by also rotating the sample 420 in an H direction in addition to the rotation of the sample 420 as illustrated by a solid line and a dashed line. The change in absorbance of the polarizing plate 440 is observed by rotating the polarizing plate 440 in the H direction. FIG. 5B is a graph for explaining a change in absorbance of the electromagnetic wave resonators when rotating the polarizing plate, and FIG. 5C is a graph for explaining a change in absorbance of the electromagnetic wave resonators when rotating the sample.

When the electromagnetic wave resonators in the sample 420 are regularly arranged, the absorbance of the linear polarized light caused by the electromagnetic wave resonators included in the sample 420 depends on an angle between a direction of the linear polarized light and a direction of the regular arrangement of the electromagnetic wave resonators. Hence, as illustrated by a solid line in FIG. 5B, when the polarizing plate 440 is rotated, the absorbance of light caused by the electromagnetic wave resonators included in the sample 420 varies. Furthermore, as illustrated by a solid line in FIG. 5C, when the sample 420 is rotated by a unit to rotate the sample 420 the absorbance of light caused by the electromagnetic wave resonators included in the sample 420 varies.

In addition, when the electromagnetic wave resonators in the sample 420 are randomly arranged, even when the polarizing plate 440 is rotated as illustrated by a dashed line in FIG. 5B, the absorbance of light caused by the electromagnetic wave resonators included in the sample 420 does not depend on the rotation of the pluralizing plate 440. Furthermore, as illustrated by a dashed line in FIG. 5C, even when the sample 420 is rotated, the absorbance of light caused by the electromagnetic wave resonators included in the sample 420 does not depend on the rotation of the sample 420.

[Regarding Form of Metamaterial]

The metamaterial manufactured by the embodiments of the present invention may be provided in any form.

A description is given below of some forms of the metamaterial with reference to the drawings.

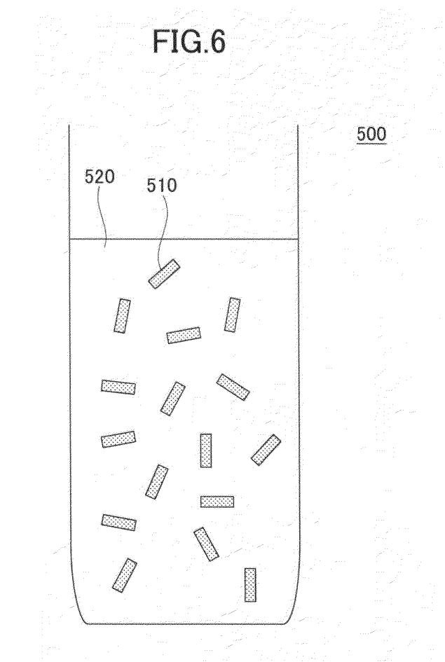

FIG. 6 schematically illustrates a form of the metamaterial.

The metamaterial may be provided in a state of separating the electromagnetic wave resonators from the support.

For example, in a sample of FIG. 6, a metamaterial 500 is provided in a state of dispersing electromagnetic wave resonators 510 in a liquid 520.

For example, by dissolving only the support selectively, such a form of metamaterial 500 can be provided.

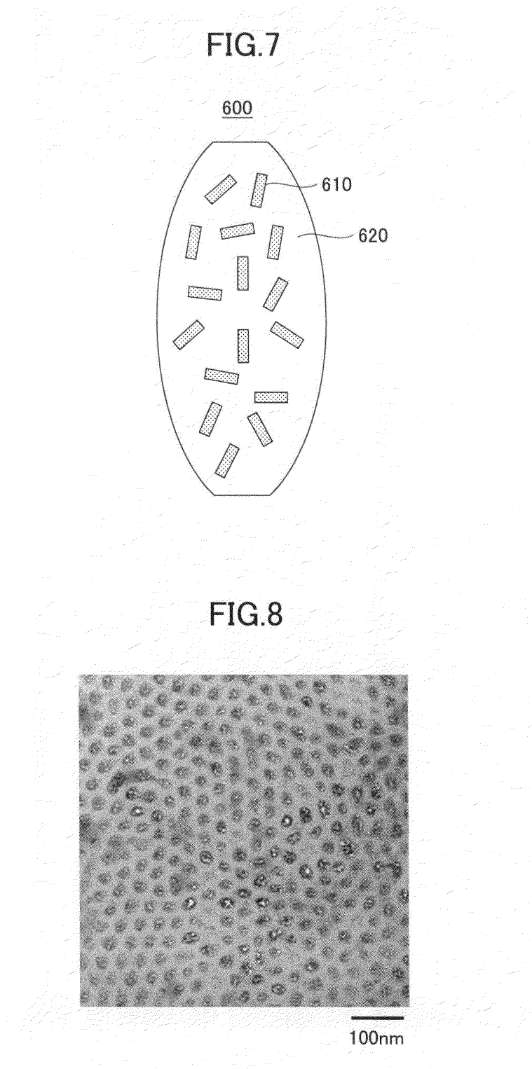

FIG. 7 schematically illustrates another form of metamaterial.

In an example of FIG. 7, a metamaterial 600 is configured as an optical device made of a hardened body 620 of resin and electromagnetic wave resonators 620 such as a lens.

In the metamaterial 600, the electromagnetic wave resonators 610 are irregularly (randomly) dispersed in the hardened body 620 of resin. Due to this, the metamaterial 600, for example, functions as a lens having isotropic physical properties to a direction of polarization of an electromagnetic wave (e.g., a relative magnetic permeability, a refractive index, a dispersion and the like). Moreover, by properly designing the electromagnetic wave resonators 610 dispersed in the hardened body 620 of resin, a lens having adjusted isotropic physical properties (e.g., a relative magnetic permeability, a refractive index, a dispersion and the like) can be provided.

In addition to these forms, it is obvious for a person skilled in the art to be able to provide a metamaterial in a variety of forms.

For example, in the form illustrated in FIGS. 4A and 4B, by transforming the electromagnetic wave resonators 310 arranged in the columns 190 of the support 200 into an adhesive material, the support 200 and the electromagnetic wave resonators 310 may be separated from each other. Such an adhesive material may be, for example, silicone rubber and the like. In this case, a sheet material made of silicone rubber and having an arrangement of the electromagnetic wave resonators 310 can be obtained.

A detailed description is given below of working examples of the embodiments of the present invention.

### Working Example 1

A metamaterial according to the embodiments was produced by the following method.

[Preparation of Substrate Having Hydrophilic/Hydrophobic Phase-Separated Film]

To begin with, a block copolymer containing chemical formulas illustrated in the following formula (2) and formula (3) was prepared by a publicly known method.

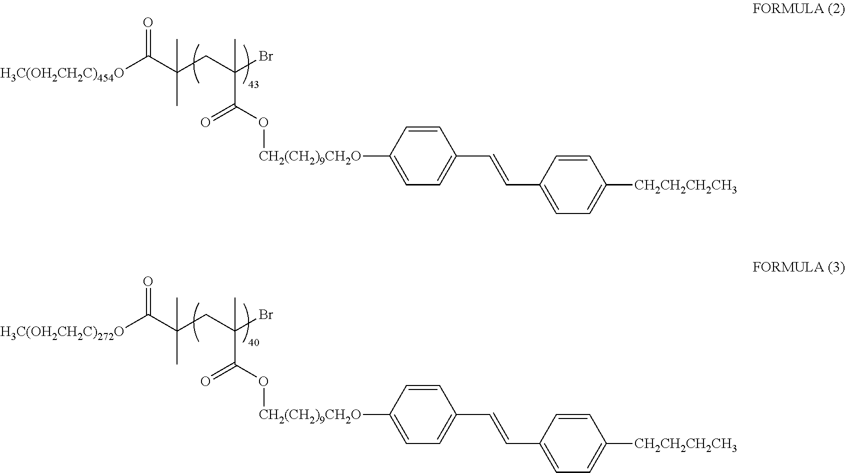

A method for preparation of these block copolymers is, for example, disclosed in Japanese Laid-Open Patent Application Publication No. 2012-1787. By dissolving these block copolymers in toluene at a predetermined ratio, a toluene solution of a block copolymer concentration of four percent by weight was prepared.

TABLE 1 shows a mixing ratio of the block copolymer in each example. Here, in TABLE 1, a chemical compound shown in the chemical formula (2) is expressed as “P454”, and a chemical compound shown in the chemical formula (3) is expressed as “P272.”

TABLE 1

| | | Average | Molecular Weight | Molecular Weight | Weight Percent |
|---|---|---|---|---|---|
| | Mixing Ratio | Molecular | of Hydrophilic | of Hydrophobic | of Hydrophilic |
| | (P454:P272) | Weight | Polymer Chain | Polymer Chain | Molecular Chain (%) |
| Example 1 | P454 | 46179 | 26786 | 19393 | 58 |
| | Simple Substance | | | | |
| Example 2 | 2:1 | 42148 | 23206 | 18942 | 55 |
| Example 3 | 1:1 | 40133 | 21417 | 18716 | 53 |
| Example 4 | 1:2 | 38118 | 19627 | 18491 | 50 |
| Example 5 | P272 | 34088 | 16048 | 18040 | 47 |
| | Simple Substance | | | | |

Next, a silicon wafer was prepared, and after cleaning a surface of the silicon wafer by ultraviolet-ozone treatment, the surface of the wafer was coated with the toluene solution by spin coating.

After that, by drying the silicon wafer, a silicon wafer coated with the block copolymers was obtained.

Next, a heating treatment was performed on the silicon wafer at 140° C. for 24 hours. By doing this, hydrophilic/hydrophobic phase-separated film of the block copolymer was formed on the silicon wafer in all working examples.

FIG. 8 shows a TEM (Transmission Electron Microscope) image of an example of a column structure according to the embodiments of the present invention. In taking the TEM image, a staining treatment is performed on a sample by using ruthenium oxide. Here, FIG. 8 is an image of the working example 3 in TABLE 1.

As illustrated in FIG. 8, the hydrophilic/hydrophobic phase-separated film had a column structure in which a portion of the hydrophilic liquid phase was arranged in a hexagonal arrangement. A diameter of each column was about 25 nm, and a distance between the adjacent columns (i.e., a length of a side of a hexagon of the hexagonal arrangement) was about 40 nm.

[Produce of Support]

Next, the obtained silicon wafer with the hydrophilic/hydrophobic phase-separated film was immersed in a silica gel solution, and the silica gel was packed in the hydrophilic/hydrophobic phase-separated film. At this time, the silica gel was formed up to the same height as that of the column structure of the hydrophilic liquid phase of the hydrophilic/hydrophobic phase-separated film.

By irradiating the obtained silicon wafer filled with the silica gel with an electron beam (EB), the silica gel was bridged (hardened), and the hydrophilic/hydrophobic phase-separated film was selectively removed from the silicon wafer by further EB irradiation.

This served to form a support with the column-like portion and the silicon wafer.

A diameter of each of the columns of the obtained support was about 23 nm; a distance between the adjacent columns was about 37 nm; and a height of the column was about 62 nm.

By the working example 1, it was confirmed that forming the support including the columns having a uniform height is possible by the method of manufacturing the metamaterial according to the embodiments.

### Working Example 2

A hydrophilic/hydrophobic phase-separated film was formed on a silica glass substrate in a similar way to the working example 1, except that the silica glass substrate both surfaces of which were polished was used instead of the silicon wafer used in the working example 1. Here, the mixing ratio of the block copolymers was made P454:P272=1:1 (the conditions of working example 3 in TABLE 1).

Next, by applying a silica gel solution to the obtained silica glass substrate with the hydrophilic/hydrophobic phase-separated film by a spin coating method, a hydrophilic phase column area of the hydrophilic/hydrophobic phase-separated film was filled with the silica gel. At this time, the silica gel was formed to be higher than the column structure of the hydrophilic liquid phase of the hydrophilic/hydrophobic phase-separated film.

After drying the obtained silica glass substrate filled with the silica gel, the silica gel film formed to be higher than the column structure of the hydrophilic liquid phase was peeled off and removed. By doing this, a silica glass substrate filled with the silica gel was obtained in which the silica gel was formed as high as the column structure of the hydrophilic liquid phase of the hydrophilic/hydrophobic phase-separated film.

By performing a predetermined heat treatment for the obtained glass substrate filled with the silica gel, the hydrophilic/hydrophobic phase-separated film was selectively decomposed and removed from the silica glass substrate.

This allowed a support with the column-like portion and the silica glass substrate to be formed.

A diameter of each column of the obtained support was about 18 nm; a distance between the adjacent columns about 31 nm; and the height of the column was about 200 nm.

[Arrangement of Electromagnetic Wave Resonators]

Subsequently, by providing an electromagnetic wave resonator on a top end of each column-like portion of the obtained support, a metamaterial was produced. In the working example, silver was selected as the electromagnetic wave resonator.

The electromagnetic wave resonator was placed on the top end of each column-like portion of the support so as to form an approximate inverse U-shape by physically evaporating and depositing the silver from different two directions relative to the support.

Here, a first direction was made the direction of arrow 330 in FIGS. 4A and 4B as described above, which was a direction perpendicular to one side of the hexagonal unit arrangement when seen from the extending (lengthwise) direction (a Z direction) of the column-like portion, and a direction inclined at a θ angle in a clockwise fashion relative to the Z direction when seen from a direction perpendicular to the YZ plane. Here, the angle θ was made equal to 10 degrees. Moreover, a second direction was made the direction of the arrow 340 in FIGS. 4A and 4B as described above, which was a direction perpendicular to one side of the hexagonal unit arrangement when seen from the extending (lengthwise) direction (Z direction) of the column-like portion, and a direction inclined at a φ angle in a counterclockwise fashion relative to the Z direction when seen from a direction perpendicular to the YZ plane. Here, the angle φ was made equal to −θ=10 degrees.

Electromagnetic wave characteristics (resonance characteristics) were measured using the obtained metamaterial. The electromagnetic wave characteristics were measured by irradiating the metamaterial with polarized light in a direction of a magnetic field penetrating through an inductor of the electromagnetic resonator and by measuring the obtained optical absorption spectrum.

As a result of the measurement, polarization direction dependency was confirmed in the magnetic field absorption, and it was found that the metamaterial according to the working example had a resonator structure that caused magnetic resonance.

### Working Example 3

A glass substrate with Indium Tin Oxide provided on a surface thereon was prepared. This glass substrate was treated by ultrasonic cleaning with an organic solvent, and then cleaned by ultraviolet treatment.

The glass substrate after cleaning was treated by dip treatment using a SAM material. This causes a SAM film to attach to a surface of the ITO film of the glass substrate.

A glass substrate coated with a hydrophilic/hydrophobic phase-separated film on a surface of the SAM film was obtained by a method similar to the working example 1 for the glass substrate to which the SAM film was attached. Here, the mixing ratio of the block copolymers was made P454:P272=1:1 (the conditions of the working example 3 in TABLE 1), and heat treatment conditions were made at 140° C. for an hour.

A diameter of the columns of the hydrophilic/hydrophobic phase-separated film was about 15 nm, and a height of the columns was about 150 nm.

Next, electrodeposition of a cerium oxide film was performed on the hydrophilic/hydrophobic phase-separated film using the obtained glass substrate with the hydrophilic/hydrophobic phase-separated film. An electrodeposit of the cerium oxide was packed into the hydrophilic liquid phase portion of the hydrophilic/hydrophobic phase-separated film by the electrodeposition of the cerium oxide film. Here, the electrodeposition was performed until the cerium oxide film became as high as the columns of the hydrophilic liquid phase of the hydrophilic/hydrophobic phase-separated film.

Here, since a method of the electrodeposition of the cerium oxide film is well known to a person skilled in the art, a further description is not given here.

By treating the glass substrate filled with the cerium oxide by plasma ashing treatment, the hydrophilic/hydrophobic phase-separated film was selectively removed from the glass substrate.

This served to form a support including the column-like portions and the glass substrate.

A metamaterial was produced according to the working example by performing a method similar to the working example 2 for the obtained support except that aluminum was used as the material of the electromagnetic wave resonators.

The electromagnetic wave characteristics (resonance characteristics) were measured by using the obtained metamaterial. The electromagnetic wave characteristics were measured by irradiating the metamaterial with the polarized light in the direction of the magnetic field penetrating through the inductor of the electromagnetic wave resonators and by measuring the obtained light absorption spectrum.

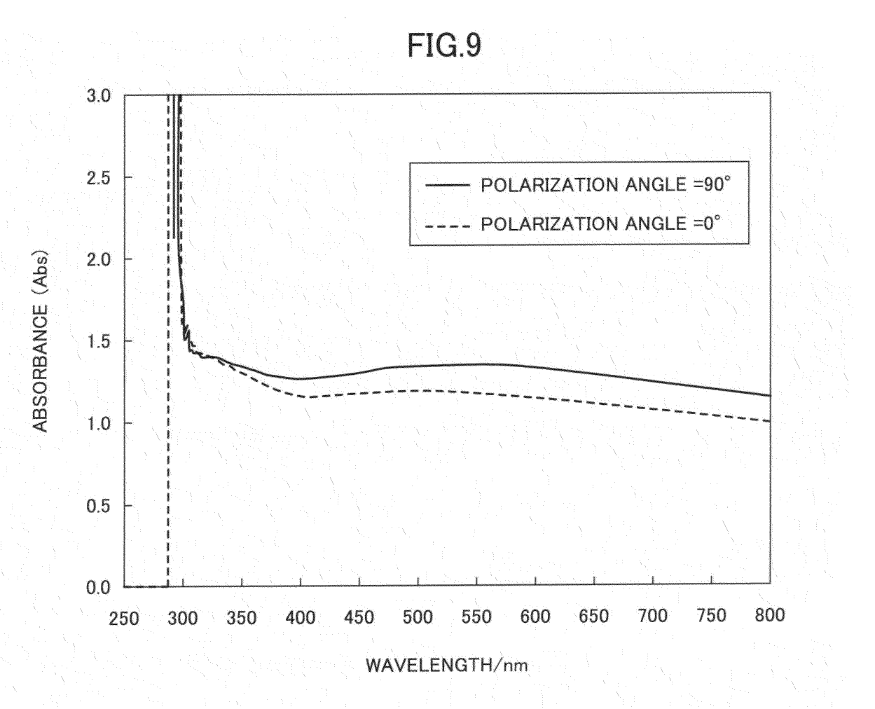

FIG. 9 shows an example of a light absorption spectrum of a metamaterial according to the working example. A solid line in FIG. 9 is a light absorption spectrum when an angle of polarization is 90 degrees, and a dashed line is a light absorption spectrum when the angle of polarization is 0 degrees.

As shown in FIG. 9, in the metamaterial according to the working example 3, the light absorption was acknowledged to be broader, and the polarization direction dependency in the magnetic absorption was confirmed in a broad wavelength range including a visible region. This makes it clear that the metamaterial according to the working example had the resonator structure that caused the magnetic resonance.

As described above, according to the embodiments of the present invention, a method of more efficiently manufacturing a metamaterial can be provided.

All examples recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention.

Further, the present invention is not limited to these embodiments, but variations and modifications may be made without departing from the scope of the present invention.

What is claimed is:

1. A method for manufacturing a metamaterial including an electromagnetic wave resonator that resonates with an electromagnetic wave, the method comprising steps of:
(a) forming a support including a portion where the electromagnetic wave resonator is to be formed; and
(b) arranging the electromagnetic wave resonator in the support by evaporating a material to form the electromagnetic wave resonator and depositing the evaporated material on the portion of the support,
wherein the step of forming the support includes steps of:
(c) forming a column structure of a hydrophilic/hydrophobic phase-separated film including a hydrophilic liquid phase area penetrating through in a thickness direction on a substrate;
(d) packing a filler into the column structure of hydrophilic/hydrophobic phase-separated film including the hydrophilic liquid phase penetrating through in the thickness direction so as to form the filler as high as the column structure; and
(e) obtaining the support including the filler by selectively removing at least a part of the hydrophilic/hydrophobic phase-separated film from the hydrophilic/hydrophobic phase-separated film including the filler.

2. The method as claimed in claim 1, wherein the step (c) includes a step of:
(c1) forming the column structure of the hydrophilic/hydrophobic phase-separated film in which the hydrophilic liquid phase area is a hexagonal arrangement by utilizing a microphase separation phenomenon of a block copolymer on the substrate.

3. The method as claimed in claim 1, wherein the step (d) includes steps of:
(d1) packing the filler into the column structure of the hydrophilic/hydrophobic phase-separated film including the hydrophilic liquid phase penetrating through in the thickness direction so as to form the filler higher than the column structure;
(d2) drying the formed filler; and
(d3) peeing off and removing a part of the dried filler that is formed higher than the column structure.

4. The method as claimed in claim 1, wherein the filler is made of a metal, and the step (d) includes a step of:
(d1) depositing the metal in the column structure of the hydrophilic/hydrophobic phase-separated film including the hydrophilic liquid phase penetrating through in the thickness direction by electrodeposition.

5. The method as claimed in claim 1, wherein the filler is made of a non-metal, and the step (d) includes a step of:
(d1) depositing the non-metal in the column structure of the hydrophilic/hydrophobic phase-separated film including the hydrophilic liquid phase penetrating through in the thickness direction by electrodeposition.

6. The method as claimed in claim 1, wherein the portion of the support includes a column, and the material to form the electromagnetic wave resonator is deposited on a top surface of the column and at least a part of a side surface of the column by evaporating and depositing the material to form the electromagnetic wave resonator from a first direction on the portion of the support in step (b).

7. The method as claimed in claim 1, wherein the step (b) includes a step of:
evaporating and depositing the material to form the electromagnetic wave resonator on the portion of the support from two or more different directions.

8. The method as claimed in claim 1, wherein the electromagnetic wave resonator is deposited on the portion formed into an approximately inverted U shape when seen from a side direction of the support.

9. The method as claimed in claim 1, wherein the material to form the electromagnetic wave resonator is not deposited on a location other than the portion of the support.

10. The method as claimed in claim 1, wherein the support is made of a material permeable to the electromagnetic wave.

11. The method as claimed in claim 1, wherein the step (b) includes a step of:
physically evaporating and depositing the material to form the electromagnetic wave resonator on the portion of the support.

12. The method as claimed in claim 1, wherein the material to form the electromagnetic wave resonator is at least one material selected from a group consisting of a metal, graphene, indium tin oxide, zinc oxide and tin oxide.

13. The method as claimed in claim 1, wherein the step (b) includes steps of:
(b1) evaporating and depositing a metal film on the portion of the support; and
(b2) evaporating and depositing a graphene film on the metal film.

14. The method as claimed in claim 13, further comprising steps of:
(b3) integrating the support including the graphene film with a second support so as to set a side including the graphene film at an inner side; and
(b4) obtaining the second support including the graphene film by selectively removing the support and the metal film.

15. The method as claimed in claim 1, further comprising steps of:
(f1) selectively dissolving the support in a liquid; and
(f2) forming a metamaterial in a state of the electromagnetic wave resonator being dispersed in the liquid.

16. The method as claimed in claim 1, further comprising a step of:
(g) transforming the electromagnetic wave resonator arranged in the support into an adhesive material.

17. The method as claimed in claim 1, wherein the step (c) includes a step of:
(c1) forming a self-assembled monolayer film on the substrate.
